(19) United States
(12) Patent Application Publication
(10) Pub. No.: US 2025/0317039 A1
(43) Pub. Date: Oct. 9, 2025

(54) Rotor of a Squirrel-Cage Motor, and Method for Producing the Motor

(71) Applicant: Innomotics GmbH, Nuernberg (DE)

(72) Inventor: Erik KROMPASKY, Nucice (CZ)

(21) Appl. No.: 18/864,770

(22) PCT Filed: May 9, 2023
(86) PCT No.: PCT/EP2023/062279

§ 371 Date: Nov. 11, 2024

(30) Foreign Application Priority Data
May 13, 2022 (EP) 22173360

(51) Int. Cl. H02K 17/16; B33Y 80/00; H02K 15/023

(52) U.S. Cl. CPC H02K 17/168; B33Y 80/00; H02K 15/023

(57) ABSTRACT

A rotor of a squirrel-cage motor and a method for producing the same, wherein the rotor has a squirrel cage winding, and rotor bars of the squirrel cage winding extend in the axial direction through a cylindrical rotor body and are interconnected by end rings at respective end faces of the rotor body, and where the end rings are applied directly to the end faces of the cylindrical rotor body via an additive manufacturing method.

### CROSS-REFERENCE TO RELATED APPLICATIONS

This is a U.S. national stage of application No. PCT/EP2023/062279 filed 9 May 2023. Priority is claimed on European Application No. 22173360.3 filed 13 May 2022, the content of which is incorporated herein by reference in its entirety.

### BACKGROUND OF THE INVENTION

### 1. Field of the Invention

The invention relates to a motor of a squirrel-cage motor as well as to a method for the production thereof.

### 2. Description of the Related Art

In asynchronous machines, in most cases what is known as a squirrel cage is provided in a rotor, which is mounted such that it can rotate relative to a stator. The rotor of the asynchronous machine is therefore also referred to as a cage rotor or squirrel-cage rotor. The squirrel cage has short-circuit bars, which are generally arranged parallel or slightly obliquely to the axis of rotation of the cage rotor, i.e., extending in the axial direction.

The short-circuit bars are inserted into the rotor base body, which in most cases is formed as a plate stack consisting of a large number of sheet metal plates stacked adjacently to one another axially.

The short-circuit bars are loaded into the plate stack in recesses or slots. At their ends, the short-circuit bars are electrically interconnected by short-circuit rings, which are arranged at both end-face ends of the rotor base body.

An example of a squirrel-cage rotor of an asynchronous machine is described in DE 195 42 962 C1.

During the operation of the electric machine, strong currents are induced in the squirrel cage due to varying magnetic fields. In order to keep the resistance losses low in this context, the squirrel cage generally consists of a material with high electrical conductivity, such as copper, aluminum or an alloy using such substances, for example.

However, these materials have a relatively low mechanical strength.

If the rotor is accelerated to high rotational speeds, the components of the squirrel cage, in particular the exposed short-circuit rings, therefore tend to deform due to centrifugal forces. A reduction of the strength of the components, as can occur at the high temperatures frequently occurring during operation, additionally amplifies the deformation tendencies.

It is therefore proposed in DE 102014220267 A1 to protect the mechanically less-stable short-circuit rings of the squirrel cage from radial deformation, for example, due to strong centrifugal forces that occur at high rotational speeds, via protective disks, which can be arranged similarly to a covering plate on an end face of the plate stack and which can stabilize the short-circuit ring using a region that is close to the edge and is curved axially away from the plate stack.

EP 3 823 142 A1 discloses a squirrel-cage rotor in which a supporting element made of high-strength material is located radially within the short-circuit rings to absorb the centrifugal forces and is connected to the short-circuit ring with a material fit, at least in sections.

In order to avoid deformations of the short-circuit ring, they are conventionally also supported by bandages encompassing from the outside.

The foregoing measures increase costs and complexity of the asynchronous machine.

### SUMMARY OF THE INVENTION

In view of the foregoing, it is therefore an object of the invention to provide a rotor of a squirrel-cage motor, which is suitable for high rotational speeds and is simple to produce.

This and other objects and advantages are achieved in accordance with the invention by a method and a rotor of a squirrel-cage motor with a squirrel cage, where rotor bars of the squirrel cage extend in the axial direction through a cylindrical rotor body and are each interconnected by short-circuit rings on or close to the end faces of the rotor body, where the short-circuit rings are applied to the end faces of the cylindrical rotor body directly via an additive manufacturing method.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in more detail on the basis of figures, in which, by way of example:

FIGS. 1, 2, 3 and 4 show different embodiments of a rotor in accordance with the invention;

FIGS. 5, 6 and 7 show further embodiments with a rotor with a laminar structure; and

FIG. 8 is a flowchart of the method in accordance with the invention.

### DETAILED DESCRIPTION OF THE EXEMPLARY EMBODIMENTS

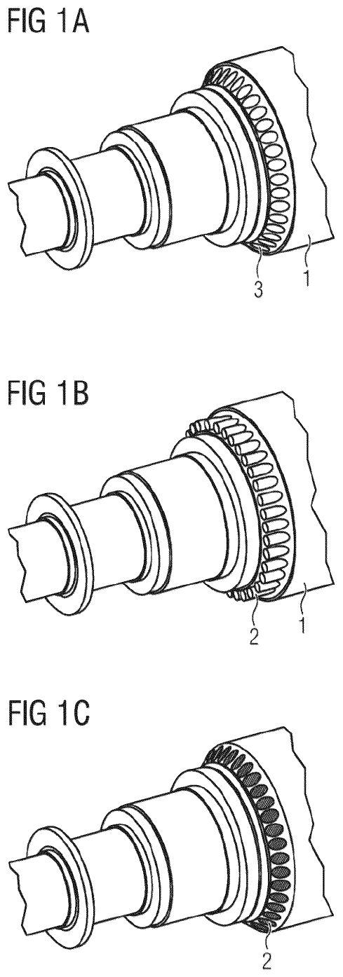

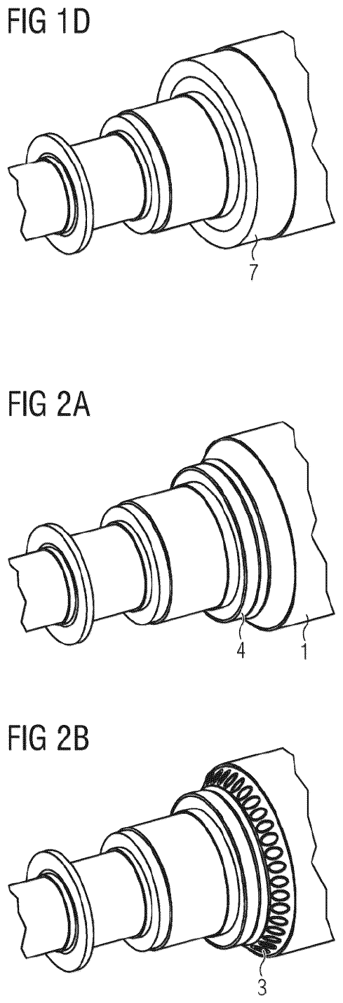

FIG. 1 shows four views of a rotor in accordance with the invention in different phases of the production process, FIG. 1a shows the cylindrical rotor body 1 before being populated with the short-circuit bars 2 with the bore holes, which are provided for accommodating the rotor bars 2 and are still open, in a section (which extends conically in the exemplary embodiment) of the end face. The end face may also, however, have a different progression without limiting the invention.

FIG. 1b shows the rotor with short-circuit bars already inserted, FIG. 1c shows the rotor with processed rotor bars, so that they form a flush end with the conically running outer section of the rotor end face.

FIG. 1d then shows the finished rotor with the short-circuit ring, which has been applied to the rotor body using an additive production method (3D printing), such as preferably the “wire-feed electron beam additive manufacturing” method.

Alternatively, however, it would also be possible to use the “cold spray additive manufacturing”, “wire/powder-feed laser metal deposition”, “friction deposition additive manufacturing”, “rotary friction welding” or “ultrasonic additive manufacturing” methods for the application procedure, for example.

By way of the method, a stable bond is achieved between the short-circuit ring, which can consist of copper, aluminum or suitable alloys, for example, and the rotor body that is made of steel, for example. Due to this stable bond, the resisting force of the short-circuit ring in relation to centrifugal forces is considerably increased and it becomes possible to use the rotor for higher rotational speeds with only a small material and production outlay.

The additive methods can be combined with further production methods, such as “galvanization”, “tampon galvanization”, “electron beam welding”, “laser beam welding”, “soldering processes” or “explosion cladding” for example, in order to produce a long-lasting connection between various materials.

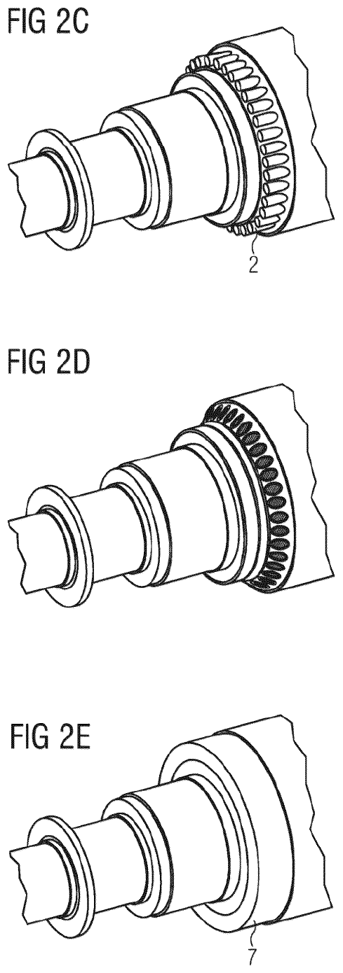

FIG. 2 shows the different phases of the production of a further rotor in accordance with the invention where, as shown in FIG. 2a, in a first step, a thin copper layer or a desired material combination is applied to the end face of the rotor using an additive manufacturing method, or also via galvanic coating or explosion cladding, with this being followed by the bore holes for the rotor bars, FIG. 2b, the insertion of the rotor bars, FIG. 2c, the flush end, 2d, and the application of the short-circuit rings 7, FIG. 2e.

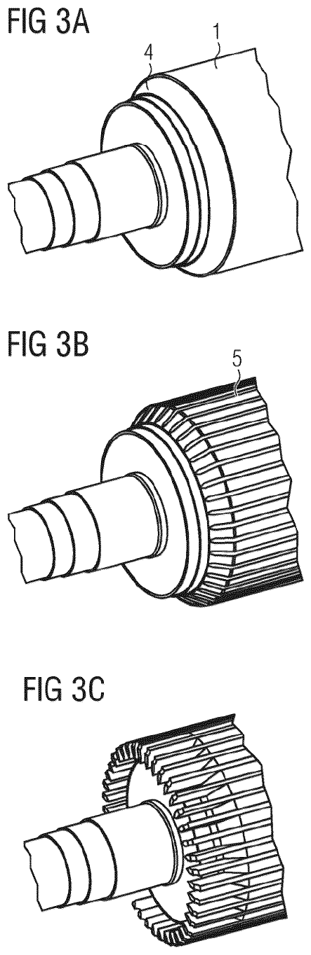

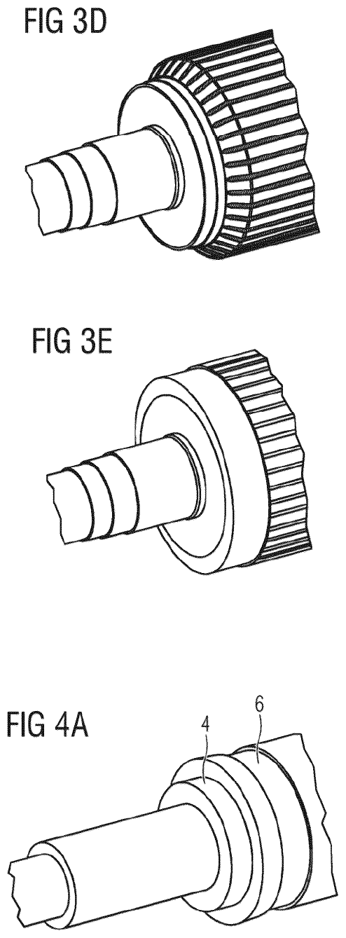

FIG. 3 shows a further exemplary embodiment, in which the rotor bars 2 are formed in a bar-like manner and are inserted into slots 5 of the rotor 1. Also in this exemplary embodiment, in a first step, a thin copper layer or a desired material combination is applied to the end face of the rotor 1, FIG. 3a, but this only occurs if the additive manufacturing method is not suitable for a direct application procedure on the shaft/rotor bar; following this, the slots 5 for accommodating the rotor bars 2 are milled, FIG. 3b, the rotor bars 2 are inserted, FIG. 3c, and shortened to be flush, FIG. 3d, and the actual short-circuit ring 7 is applied.

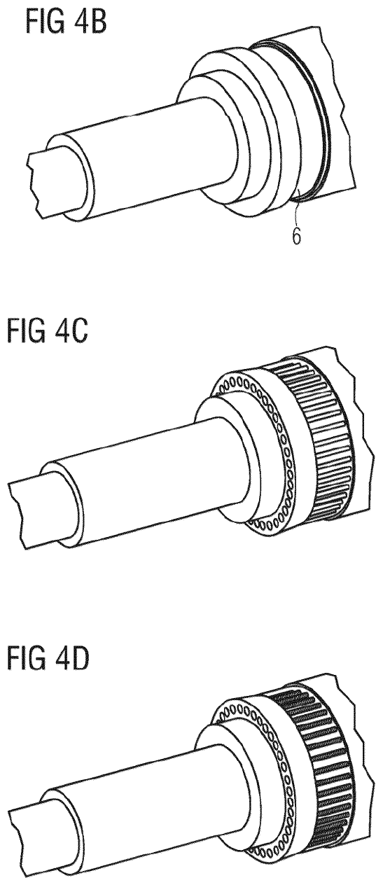

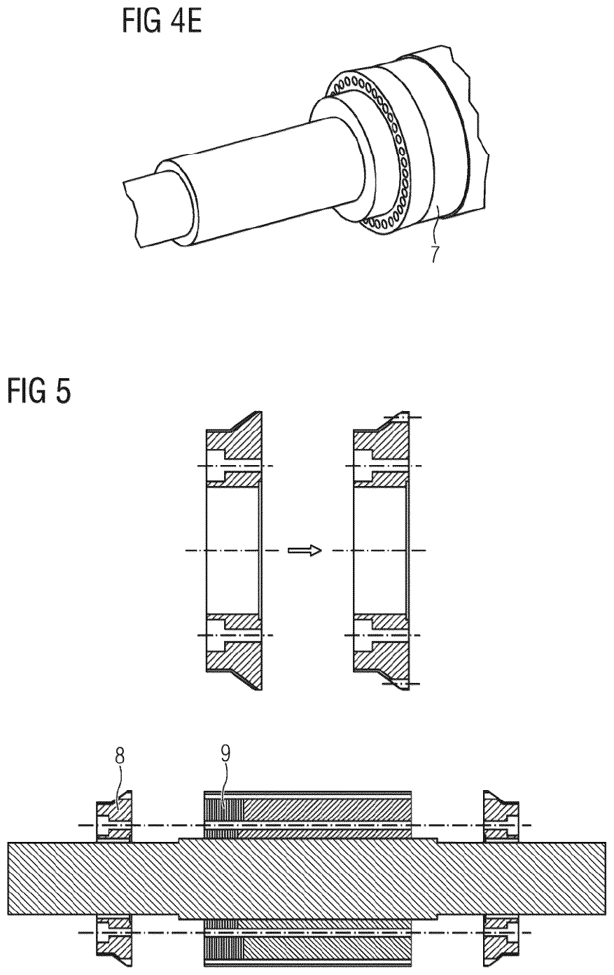

FIG. 4 shows a further exemplary embodiment in which, as opposed to the preceding examples, the short-circuit ring 7 is not applied to the end face of the rotor directly, but rather is inserted somewhat spaced apart from the end face in a surrounding groove 6 of the rotor. The approach during the production of the rotor 1, however, corresponds largely to the approach in the other examples.

FIGS. 5, 6 and 7 each show exemplary embodiments with a rotor body 1, which is constructed as a plate stack consisting of a large number of sheet metal plates 9 stacked adjacently to one another axially. On the end faces, the plate stack is finished by steel rings 8, to which the short-circuit rings 7 are applied. It should be noted that the invention can also be applied in the same manner in the case of a solid rotor body made of steel.

In the exemplary embodiment depicted in FIG. 5, the steel rings 8 have, for example, a conically running section of the end face, where the short-circuit rings are shaped so that, together with the rotor base body, they form a cylinder with an end face that extends normally in relation to the axis of rotation in a unified manner.

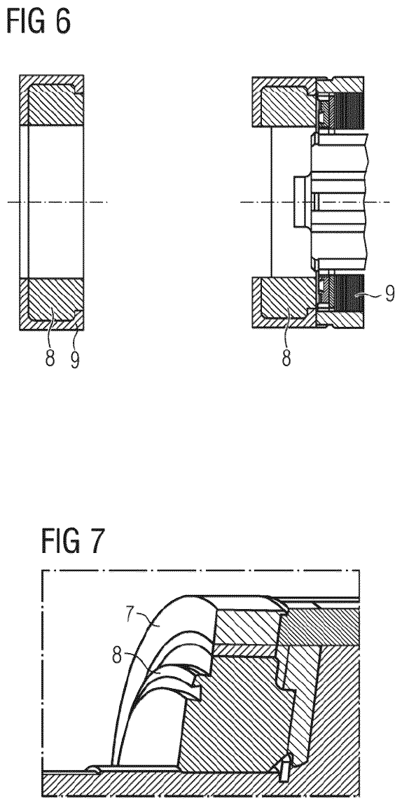

In the exemplary embodiments of FIGS. 6 and 7, the steel rings 8 have a smaller circumference than the rotor body, where the short-circuit rings 7 are applied to the circumference of the steel rings 8 in a manner in which a cylinder with a unified peripheral surface is formed following the application with the rotor base body.

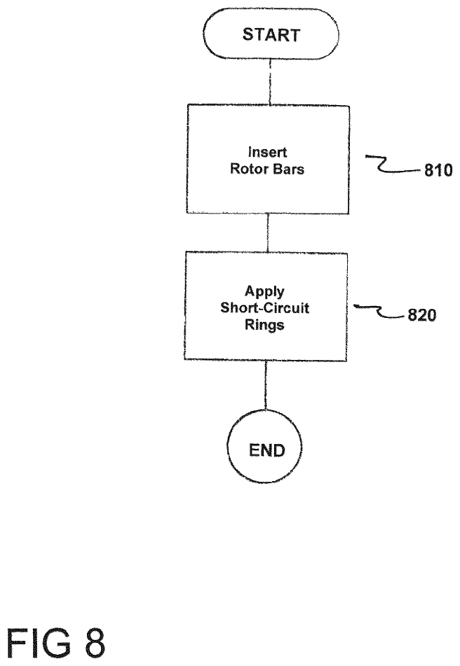

FIG. 8 is a flowchart of the method for producing the rotor of a squirrel-cage motor, where the method comprises inserting rotor bars 2 of the squirrel cage into a cylindrical rotor body 1 and into prepared recesses 3 of the cylindrical rotor body 1, as indicated in step 810, and comprises applying short-circuit rings 7 to or proximate to end faces 4 of the cylindrical rotor body 1 directly via an additive manufacturing method, as indicated in step 820.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-11. (canceled)

12. A rotor of a squirrel-cage motor with a squirrel cage, wherein rotor bars of the squirrel cage motor extend in an axial direction through a cylindrical rotor body and are each interconnected by short-circuit rings on or proximate to end faces of the rotor body, and wherein the short-circuit rings are applied to the end faces of the cylindrical rotor body directly via an additive manufacturing method.

13. The rotor as claimed in claim 12, wherein the additive manufacturing method comprises a “wire feed electron beam additive manufacturing” method.

14. The rotor as claimed in claim 12, wherein the additive manufacturing method comprises a “cold spray additive manufacturing” method.

15. The rotor as claimed in claim 12, wherein the additive manufacturing method a “wire/powder-feed laser metal deposition” method.

16. The rotor as claimed in claim 12, wherein the additive manufacturing method comprises a “friction deposition additive manufacturing” method or “rotary friction welding”.

17. The rotor as claimed in claim 12, wherein the additive manufacturing method comprises a “ultrasonic additive manufacturing” method.

18. The rotor as claimed in claim 13 wherein the additive manufacturing method is combinable with galvanization, explosion cladding, electron beam welding, laser beam welding or soldering processes.

19. The rotor as claimed in claim 14, wherein the additive manufacturing method is combinable with galvanization, explosion cladding, electron beam welding, laser beam welding or soldering processes.

20. The rotor as claimed in claim 15, wherein the additive manufacturing method is combinable with galvanization, explosion cladding, electron beam welding, laser beam welding or soldering processes.

21. The rotor as claimed in claim 16, wherein the additive manufacturing method is combinable with galvanization, explosion cladding, electron beam welding, laser beam welding or soldering processes.

22. The rotor as claimed in claim 17, wherein the additive manufacturing method is combinable with galvanization, explosion cladding, electron beam welding, laser beam welding or soldering processes.

23. The rotor as claimed in claim 12, wherein the short-circuit rings are made of copper or copper alloys.

24. The rotor as claimed in claim 12, wherein the short-circuit rings are made of aluminum.

25. The rotor as claimed in claim 12, wherein the cylindrical rotor body includes a plate stack consisting of a plurality of sheet metal plates stacked adjacently to one another in an axial direction.

26. A method for producing the rotor of a squirrel-cage motor, the method comprising:
inserting rotor bars of the squirrel cage into a cylindrical rotor body and into prepared recesses of the cylindrical rotor body; and
applying short-circuit rings to or proximate to end faces of the cylindrical rotor body directly via an additive manufacturing method.
